(19) United States
(12) Patent Application Publication
(10) Pub. No.: US 2004/0158483 A1
(43) Pub. Date: Aug. 12, 2004

(54) Business and technological method for a flexible automobile sharing transit on demand

(76) Inventor: Jacques M. Lecouturier, San Rafael, CA (US)

Correspondence Address: Jacques M. Lecouturier, 350 Holly Drive, San Rafael, CA, 94903, US

(21) Appl. No.: 10/361,258

(22) Filed: Feb. 10, 2003

(51) Int. Cl. G06F 17/60

(52) U.S. Cl. 705/6

(57) ABSTRACT

A door-to-door flexible automobile sharing transit (F.A.S.T.) system of instant ridesharing on demand for commuters utilizes a fleet of conforming vehicles equipped with GPS tracking, on-board navigational guidance, and wireless receiver and transmitter for interactive communication with a central ride matching center. Alternate routes for any commute trip are each expressed by unique sequences of codes, one sequence for each direction, and stored in a database. Flexibility of routes maximizes opportunities to share rides based on real time vehicles positions, passengers' pick-up locations, and statistical data. A center monitors positions of vehicles in transit from GPS wireless input. Upon request for a ride, nearest driver is guided to pick-up passenger. Optimum route is retrieved with software programs from database by comparing routes and eliminating second choices. All participants are screened before affiliation. Passengers are billed monthly for their rides. Drivers are compensated for transporting passengers. A variety of bonuses increase system efficiency.

### BACKGROUND OF THE PRESENT INVENTION

Categories of Commuters

Commuters fall in three broad categories: (i) people having more time than money, (ii) people having more money than time, and (iii) people balancing the value of time and money to achieve a fast, convenient, flexible, and reliable commute at the least cost. Commuters in the first category prefer buses or trains where governments subsidize fares with taxes. Commuters in the second category encompass solo drivers in luxury vehicles, smokers, drivers, and devotees to ambient music. Commuters in the third category drive solo to leave home when they choose and return from work when they choose. They were never offered a mode of transportation better than solo driving. They want transportation they depend on that is fast and reliable, a possibility never offered to them prior to the present invention. Yet they represent 80% of the commute traffic.

Riders Asked to Arrange Matches

Changing the habits of people only works when self-interest is apparent. All previous attempts at popularizing car-pooling left the final decision of identifying the proper vehicle to the rider. Advance car-pooling methods in existing art were mostly geared at reducing drivers' travel time by allowing access to fast freeway lanes, taking passengers at pre-arranged time or locations. This method, albeit his main fault of ignoring the trip back home, supports the concept that time saving is a main element of an efficient ridesharing system. Numerous systems have attempted to improve the procedure for a rider to select a most desirable vehicle at a most favorable travel time, but never offered guaranteed transportation both ways, on time and on demand. To achieve time flexibility for a return trip, a rider had to find a second driver. In practice, the time wasted to secure rides in both commuting directions far exceeded any monetary or time benefits and was the strongest deterrent to carpooling.

Complexity and Flooding of Data

Previous inventors of ridesharing system have relied on existing geographical data and accompanied navigational maps to generate routing directions (Savage, et al—U.S. Pat. No. 4,954,958). Based on such information, verbal instructions to direct drivers have been proposed (Davis, et al—U.S. Pat. No. 5,177,685). In either case, guidance tools for routing directions only intended to show a driver a route to a landmark location. Side streets and cul-de-sac seldom appear on such maps. Optimum routes were defined by general criteria having little to do with servicing commuting passengers most efficiently. An optimum commute route for a ridesharing system must pick-up and transports the most passengers in the least time. Road impediments obtained from outside sources are cumbersome to bring into the system. An enormous amount of data to be retrieved and analyzed makes a reliance on an all-encompassing data source a slow process prone to error, when speed of execution is the guarantor of desired performance. Existing information processing system have paid scant attention to speed of execution, as evidenced by Nimura, et al—U.S. Pat. No. 4,882,696. Driving assistance requiring a driver to consult with passengers if they wanted to save time, and buy an alternate route from the processing center, can be a recipe for discontent (Penzias—U.S. Pat. No. 5,604,676).

No Transport Back Home

In previous art, ideal matching conditions between drivers and passengers were predicated upon identifying all requested rides and matching each of them in real time with a driver, according to the position and destination of driver at matching time. No previous improvement has addressed the problem of guaranteeing to a rider a return trip back home. (Penzias, Behnke—U.S. Pat. No. 4,360,875). Penzias takes a car where driver wants to go to pick-up a passenger but driver never knows if a passenger is to be taken, unless previous arrangement were made. In this situation, the ability to transport a passenger on demand is negated by the lack of probability that a passenger needs to be transported at the time. In a practical case, random side-of-the-road pick-up in the morning left commuters the arduous task of finding a ride home, often in over-crowded buses, as experienced in the Oakland San Francisco corridor.

Insuring Return Home

Insuring that a seat is available to go to work and for the return trip back home was never a consideration in previous systems, making it nearly certain that unless a seat in a vehicle for the return trip was arranged in advance, the commuter could be stranded. The reason is apparent: random matching on demand in real-time cannot be achieved in both directions when variable travel distances for transported passengers are traded between drivers. Precise measures and programs need to be in place to insure a seat at the requested time, for the needed travel distance. The present improvement encompasses statistical methods, fuzzy logic, and monetary incentives to guarantee commuters a seat to go to work and to return home.

Number of Passengers

The number of passengers dictates the number of stops, and time of travel. More than three passengers decrease cost per mile for all riders but increases time of travel proportionally. Time penalty is a deterrent for drivers and passengers. In a 20 miles travel taking 30 minutes in clear traffic with three passengers, seven passengers may add 20 minutes to total travel time. To insure excess capacity in return trips back home, a five seats vehicle with the fifth seats kept vacant in the morning provides a simple solution to guarantee a seat in both directions. By improving traffic condition during peak commute hours, the present business method is in a position to restrict its operation time to few hours, which in turn increases the density of commuters, and reduce detours to pick-up passengers.

Security of Passengers

For broad public acceptance: security of passengers, conformity in vehicle appointments, and driver performance are essential elements. Security for passengers, especially women, children and elders is a vital consideration. The present invention constantly monitors all its affiliated vehicles along with the people who drive and ride them. A driver abandoning an assigned route, or stopping for no apparent and justifiable reason, immediately comes to the attention of the system operator. A mother confiding a child to the system can request that arrival of the child at destination be confirmed to her.

Such transportation benefits are invaluable for seniors, handicapped persons, non-driving students and children.

Critical Mass

To launch a successful ridesharing system requires a critical mass of qualified participants.

No methods were previously devised for an initiation phase to reach this critical mass. The main challenge to achieve critical mass must be mastered before starting operation. In well-wishing systems with anticipated progressive development, scarcity of passengers discourages drivers, while inadequate drivers and dubious vehicles deter continuous patronage by riders. All vehicles must offer conforming appointments and operate under supervised drivers' performances to be acceptable to a majority of commuters. Without this requirement satisfied, passengers are asked to guess if their rides will be comfortable, safe, and on time. Such conformity of attributes, in addition to the need for special equipments on board the automobiles, cannot be expected with a snowballing approach of voluntary drivers, freely offering their own vehicles for transport (Penzias). For drivers to perform according to public expectations, strong financial incentives and saving of time need to motivate them. Like the launching of Federal Express, the launching of the present invention cannot begin with an embryonic participation.

Impact on Parking

Retiring one commute car out of two during commute hours will have a highly beneficial impact on parking in downtown areas of large cities. Parking is always at a premium where half the parked cars come from the suburbs. The present invention opens the distinct possibility of having the commute cars rented outside commute hours. Car sharing in large cities is already being developed and the present invention would make many cars available for people who need them only during limited working hours. Also, drivers coming from the suburb can pick-up peripheral city dwellers on their way to their final destination.

Minimum Standards

To transform commuting from present crowded conditions to a fully functioning flexible automobile sharing system, a comprehensive initiation phase needs to be implemented along with the resolutions of numerous technical requirements. Participating drivers need specially equipped vehicles to receive and transmit satellite signals from a Geographic Positioning System. G.P.S. is the indispensable technology allowing the reliable tracking of vehicles in operation. Gyroscopic vehicle positioning and memory-based systems fail often due to tire slippage when evaluating distances (Davis, et al).

Other special equipments are needed aboard the driver's vehicle to provide wireless communication with a central system, that tracks and guides vehicles on constantly changing routes. On board map guidance on screen and possibly voice instructions are necessary to direct a driver to an unknown address. Expensive equipments are not likely to be acquired by drivers of privately owned vehicles unless drivers know that paying passengers are forthcoming to amortize their cost. Ownership and installation cost of necessary on-board equipments belong to the operators of the system.

Need to Overcome Special Interests

Special interests in road construction, buses, trains, and ferries, may politically interfere with the availability of a system that jeopardizes their vested interest. Such alternatives to public transportation need subsidies and taxes that can only be voted by an exasperated public looking desperately for any solution. Even a bad solution gives the public a sense that something is being done. People are responsive to societal changes when changes benefit the whole society. The massive introduction by this invention of electric and hybrid automobiles is expected to play a vital role in nullifying resistance to a new mode of transportation for commuters.

Interest of Car Makers

The purchase or lease of thousands of electric or hybrid vehicles represents an entry into an enormous potential market. Electric and hybrid vehicles manufacturers would find with the present invention a large and profitable market. It is highly probable that large automobiles manufacturers will compete to be providers of conforming vehicles, especially if incentives are properly associated with their participation. Typically, an automobile manufacturer would provide at its own risk the vehicles necessary to launch the system, for a percentage in its ownership.

Simplicity of Use

Simplicity and speed of execution are essentials to the necessary rapid launching of a flexible ridesharing system. If time to arrange a conditional rideshare twice a day, in addition to a waiting time for pick-up, exceeds the total commuting time of a solo driver, it is unlikely that such a driver will abandon solo driving. A feasible system must recognize the realities of the market place. The present invention only requires drivers and riders to call a toll free number before starting a trip, and to provide a security code. The system already knows all necessary co-ordinates and monitors the ride with a simple phone call. The time saving for participants and non-participants is expected to rapidly halve commuting time for everybody. Within reasonable variables and parameters, the present invention guarantees all riders that requests for transport are satisfied on demand. One parameter is to provide instant ridesharing during specific hours to get a high geographical density of participants and shortest detours to pick-up passengers. Without parameters, chances of performing a match between a driver and a passenger going to a same destination, at a given time of the day, and at a fixed location is not consistently possible. Transporting a passenger to a place of work appears to be a futile exercise if the passenger cannot be brought back home at the end of the day.

Combination of Motivating Factors

A ridesharing system can only achieve broad commuters participation by satisfying their interests and overcoming their objections. Commuters would continue to drive solo unless offered a faster and better commute at a lesser cost. Conditions of travel are important. It would be of no use if commuters were expected to travel in any car condition, or having to deal with dangerous drivers. Without comprehensive insurance, a serious mishap would have unfathomable repercussions. Riders must have a reason to feel secure. Interest would rapidly wane unless both drivers and riders are motivated by personal benefits. A ridesharing system is not likely to attract a wide participation unless all factors indispensable for the public to sponsor it are satisfied. The object of the present invention is to address all such factors. A choice area to implement the invention is the San Francisco North Bay with 20,000 commuters driving to San Francisco on a narrow corridor. The North Bay has a high wage population and the toll bridge offers an added incentive to using the system.

Review of Previous Art

The common denominator for the limited scope of carpooling until today is that riders have been required to personally arrange a concurrent match with a driver's route, leaving to riders the responsibility to select the most suitable driver and vehicle. This spawned the theory to improve ridesharing by offering more choices to riders. The result was a theoretical array of options with fewer participants.

While potentially of great benefit to all commuters, ridesharing systems under present conditions expects the volunteer participation of a minority, without regard to profit motive. On this reasoning, previous ridesharing systems have approached their design from the perspective of the rider's personal involvement in the completion of a match, while ignoring the rigorous mechanisms of a competitive market place. These partially conceived systems with marginal objectives postulate requirements from passengers, leaving unknown drivers to accommodate such requirements.

Previous systems were not flexible enough to satisfy the expectations and endless changing requirements of most commuters. Saving time is far more important than saving money when considering a large number of commuters. In fact, the principal and most compelling function of a private automobile is to save time, not money. Choosing the time of travel on short notice is most valuable. No system of transportation saves more time for commuting than a private automobile, even with gridlocks and time for parking. One hour saved is far more valuable to the vast majority of commuters than the expense of solo driving. The present invention is the first ridesharing in a position to offer a faster commute than private automobiles, for everybody.

On technical merits, past ridesharing systems were designed to group several passengers for the morning travel, overlooking that they would want to return from work at different hours. From this limited parameter, attempts were made for separate bookings of two one-way trips. However, considerable search time invested for each trip booking, combined with the hazard of non-completion, entirely negated any possible time saving. Passengers' monetary savings did not compensate for wasted time.

Another deterrent in previous systems was designing its operation to fit the constraints of existing technology rather than adapting technologies to fit the need of a market economy. For example, many systems tended to rely on computers and the Internet for the rider to establish a match. This is ineffective for two reasons: a) the Internet is not sufficiently used to attract a large number of commuters; and b) it is too time consuming to arrange a match by computer.

Cumbersome methods of ride arrangement have precluded passenger pick-up on short notice or when driver is en-route to a destination. When Global Positioning System was considered, it was merely an adjunct to facilitate finding the address of a passenger. The failure of experts to apply new technologies demonstrates that they are best at managing problems inherent with seasoned technologies rather than finding new solutions that may debase their expertise.

Experiments and studies have shown that passengers are sensitive to the type of car they have to board. A number of inconveniences are detrimental to the success of ridesharing: noisy engine, overused tires, broken seat belts, bent fender, smelly or worn upholstery, excessive heat or cold, open windows, music, smoking, and reckless driving. Added to unforeseeable, unchangeable, and undesirable inconveniences was the fact that financial participation could not be demanded or even expected. Oakland to San Francisco was a spontaneous ridesharing allowing drivers to use the High Occupancy Vehicle express left lane on the freeway to pick-up passengers at convenient places. However, it did not provide for the return trip.

In the absence of an enforceable policy to disallow undesirable cars, unacceptable behavior on the part of drivers or passengers, and an equitable and convenient method to establish fair financial participation, it is of no surprise that previous experiments were limited and unsuccessful.

Previous ridesharing systems paid scant attention to the safety and security of participants. Women, children, and seniors are particularly at risk boarding an unknown vehicle driven by a stranger. No measures were in place to identify drivers and exclude drivers presenting a driving risk. Passengers with a penal record or prone to anti-social behavior were not barred or weeded out. No consideration was given to legal ramifications associated with insurance and potential liability.

In the nation today, three commuters use car-pooling for every one using mass transit. The most successful ridesharing is in Northern Virginia where most participants head for the Pentagon. There was a successful carpool in Oakland, California picking up passengers off the side of the streets but not returning them home. Others attempts were organized in Bellevue, Seattle, Wash.; Houston, Tex.; and Anaheim, Los Angeles, Ontario, and Sacramento with mitigated or no success.

Studies by agencies, at the local, state, or federal levels, seeking to facilitate traffic, appear motivated to promote the use of new technologies. Technology firms lobby politicians who in turn influence agencies to fund experimentation of proposed technologies.

For example, numerous technologies are proposed to record and penalize improper use of High Occupancy Vehicle (HOV) lanes on busy freeways: Video camera, transponder, near infrared, millimeter waves, thermal infrared. A HOV lane on a freeway facilitates about 20% of commute traffic. Penalizing drivers who improperly use HOV lanes will hardly improve this percentage and HOV does nothing to ease traffic on a same corridor outside the freeway.

Under the ridesharing business method of the present invention, drivers are accountable for the condition of their vehicles, and their manner of driving and conduct. Drivers are provided with paying passengers. Payments from passengers are conveniently handled and drivers are credited with a share of the receipt. Drivers and passengers are identified and screened before subscribing. Boarding passengers are known. Misconduct from anyone can be reported and sanctioned by reprimand, and even expulsion.

Comparison with Other Inventions

The present business method derives its originality and strength from distinct attributes: No previous inventor has considered providing both drivers and passengers with a practical system performing guaranteed real-time matches on demand within specific parameters, sharing expenses, having automobiles and drivers conform to specified criteria, insuring everybody, providing security to riders, having market incentives to motivate participants, including appreciable benefits and special rewards.

No previous inventor has addressed the critical question of the commute returning trips. They offer methods for passengers to find drivers to go someplace, even on demand, (Penzias 1997 assigned to Lucent Technologies) but do not address the question of bringing these passengers back to where they left (Penzias and Behnke 1982.) What good is it to provide transport to work if the commuter is left stranded in the city, after work? This is the most crucial part of the present invention and explains why no ridesharing system has worked before.

Nomura U.S. Pat. No. 5,371,678, 1994 offers a system of finding a best route predicated on information previously stored and offsetting any on-route delays that may alter the route of the vehicle, at any given time.

The present invention relies on GPS to calculate the optimum route from any en-route vehicle position.

Martin, et al U.S. Pat. No. 5,272,638, 1993 (assigned to Texas Instrument) assigns a performance value to sequences of connected segments constituting a possible travel route, and chooses the optimum sequences by the highest value, to construct the optimum route.

Savage, et al U.S. Pat. No. 4,954,958, 1990 offers an optimum route between supplied locations.

Neukriner, et al U.S. Pat. No. 4,984,168, 1991 (assigned to Bosch) is an on-board guidance system based on diminishing grids.

Nimura, et al U.S. Pat. No. 4,882,692, 1991 offers a system based on providing memorized guidance data allowing changing course, based on calculating the tracing of executed detours.

Schreder, U.S. Pat. No. 5,504,482, 1996 (assigned to Rockwell) provides both an inertial unit and GPS for vehicle positioning and route guidance together with digitized maps to guide vehicle between two points.

Of all existing patents, Schreder comes closest to the technological aspect of the present invention.

However, the present invention does not rely on maps for vehicle guidance, but on pre-studied and stored routes that remain constant between origination and destination points. Route segments in the present invention take into consideration traffic flow and direction at different times of the day. In addition routes are structured depending on factors and variables other than simply geographic, such as the density of affiliated commuters in a particular area.

The present invention solves the problem of traffic congestion during peak commute hours and its methods of operation are designed within this parameter. It alone provides methods to insure that affiliated passengers obtain door-to-door transport, in either direction of travel, on demand, during window hours, every time they need transport. Even mass transit cannot offer that.

Cost Comparisons

A common measure of assessing cost versus benefit in urban transportation is in the initial capital investment cost to transport one passenger for one trip, and the operational cost allowing this passenger to make use of this seat for one trip over a period of time.

For example, an automobile worth $40,000 used for commuting represents an investment of $5,000 per passenger-seat if the automobile carries four passengers twice a day. The same automobile can be rented outside commute hours or concurrently hired to transport light freight, further reducing the overall cost of transportation.

By comparison, a passenger-seat on rail transit averages between $50,000 and $100,000. Operational expenses are seldom covered by fares when renewal of equipment becomes necessary. Investment for seats on buses costs less than rail transit but operational expenses are high and need subsidies.

Rail transit does not account for the invisible cost to passengers: time wasted going to and from the station, time wasted waiting for the train, parking the car or using another means of transportation to travel to the station. When all factors are considered, most rail transit commuters spend twice the time that it would take them to drive solo in normal traffic conditions.

Mass transit is principally a source for open-ended construction contracts, politically supported by solo drivers in anticipation that it will clear the road for them. Fixed transit systems merely create their own clientele by promoting growth of multi-unit residences along their tracks. For example, riders' attendance of BART in San Francisco was 100,000 daily in its first decade and went to 300,000 in its third decade. During 30 years, the number of large apartment complexes near mass transit nearly tripled. BART never improved traffic for the pre-existing commuting population as evidenced by the growing congestion on the Bay Bridge today.

Experts to support a theory, often structure surveys and present methods of traffic analysis.

Here is a case in point: a Marin County survey concludes that if commuters used alternate commute routes, 69% would save 17 minutes on average. Simple reasoning implies that saving 17 minutes needs at least 25 miles commute. This survey ignores that alternate routes would soon be clogged by increased traffic. Based on this inconsistent survey, a join “TravInfo” project was funded at a cost of $8 million to install roadway sensors, closed circuit television, ramp meters, and flow traffic meters for the bay area.

Fallacies of Public Transit

A fallacy of rapid transit is that broad public support demonstrates its desirability. Common sense dictates that most drivers support a transportation system proposing to ease traffic condition by taking other drivers off the road. Previous inventors have stressed the futility of mass transit to resolve existing traffic congestion (Behnke). Fixed mass transit clientele comes from increased population density along the track. Mass transit seldom serves the existing population and never reduces existing road congestion. A contradiction by proponents of rail systems proposes that ridesharing cannot develop broad public appeal because people won't abandon driving their own vehicles.

The country was built on automobiles. Out of 100 commuters nationwide, 30 commuters use carpooling for seven using mass transportation. Intelligent sharing of automobile use is presently the most expeditious solution to rapidly eliminate traffic congestion while reducing gasoline needs and eliminating associated environment pollutants.

Technical Fields

The U.S. Department of Transportation, Federal Transit Administration, in a letter to the Honorable Congresswoman Lynn Woolsey on Aug. 28, 2001 (copy attached), has found the invention timely to eliminate traffic congestion in busy corridors, recognized the technologies used in the presently disclosed invention as follows:

Global positioning systems

Advanced vehicle wireless communications

Automated-real time vehicle tracking and routing

Demand responsive vehicle assignment

Integration of these systems with advanced computer

Communication systems to provide enhanced transit and ride sharing services in congested corridors.

### BRIEF SUMMARY OF THE INVENTION

Acceptance of a ridesharing system for commuters is more than just matching any vehicle with any commuter looking for a free ride. The present invention guarantees transportation for commuters in crowded corridors on the premise that mass acceptance of ridesharing cannot operate successfully without satisfying the following attributes of the present invention:

(i) Availability of transport is guaranteed from home to work and from work to home, (ii) Door-to-door travel time is faster than solo driving. (iii) Transport is provided on demand. (iv) System efficiency is subordinated to peak commute hours. (v) Vehicle conforms to publicize criteria for comfort and safety. (vi) Transport of people is monitored for security. (vii) Commuting expenses are shared equitably and are less than solo driving for either drivers or passengers. (viii) Drivers and passengers are first identified and screened to become affiliated. (ix) Payments and disbursements are routinely handled separately from the rides. (x) System is financially self-sustaining. (xi) Broad societal acceptance is achieved with use of electric or hybrid vehicles.

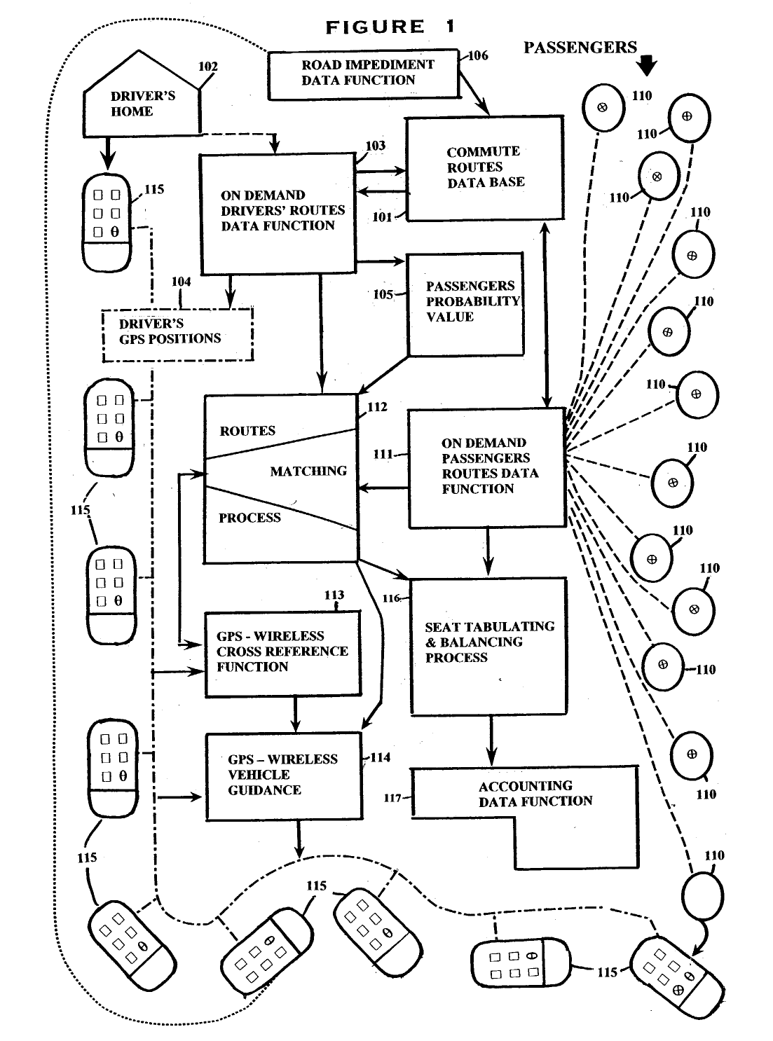

### FIG. 1. DESCRIPTION

FIG. 1 shows a schematic exemplary architecture for a central information processing center operating a system of ridesharing wherein affiliated drivers and passengers are transported on demand during commute hours in conforming affiliated vehicles guided in real time to follow alternate routes to take commuters to their destination in the shortest possible time.

Commute Routes Database 101 stores all alternate commute routes of affiliated participants, identified and stored when a participant becomes affiliated with the system. Routes are defined by distinct sequences of coded segments, for drivers and passengers, in both commute directions, and the time that it takes to travel each segment. A sequence of coded segments for a route in one direction is distinctly different from the sequence of coded segments for a route in the opposite direction, although both extremities of the commute route are the same.

An affiliated Driver 102 telephones to the Drivers' Routes Data Function 103 minutes before departing for a commute trip and provides a personal code. Data Function 103 identifies the known affiliated driver's phone number and, upon recognizing the personal code, retrieves from Commute Routes Database 101 all alternate routes susceptible to take driver from his known departing position to his known destination.

Drivers' Routes Data Function 103 searches the Passengers Probability Value Database 105 for the probability of Driver 102 finding passengers on any of driver's alternate routes stored in Database 101 going to the same destination at the same time, and identifies a route where more passengers are most likely to be picked-up Drivers' Routes Data Function 103: (i) forwards driver's alternate commute routes retrieved from Database 101 to the Passengers' Probability Value Database 105. (ii) initiates GPS tracking of Driver's Vehicle Positions 104 with G.P.S. Cross-Reference Function 113, (iii) initiates the vehicle on board GPS guidance from Vehicle Wireless Guidance 114.

Probability Value Database 105 sends the selected route to Routes Matching Process 112.

Affiliated passenger 110 telephones minutes before leaving home to Passengers on Demand Routes Data Function 111 and provides a personal code. Passengers Data function 111 (i) recognizes the phone number and personal code of passenger, (ii) retrieves passenger's alternate commute routes from Database 101, (iii) forwards alternate commute routes retrieved from Database 101 to Ride Matching Process 112, (iv) registers with Seat Tabulating and Balancing Process 116 the passenger's return trip home trip home by its corresponding home drop-off zone coded segments.

Routes Matching Process 112 forwards all driver's alternate commute return routes by coded segments to Seat Tabulating and Balancing Process 116; compares all alternate routes received from Passengers Data Function 111 with all alternate routes received from Drivers Data Function 103 and isolates a common destination on all alternate commute routes by performing the following functions: (i) searching for coded segments within passenger's drop-off zone that are also contained into one sequence of coded segments of any alternate routes susceptible to be followed by any presently en route drivers, (ii) identifying all presently En-Route Drivers 115 in drivers' real time position by coded segments from GPS Cross-Reference Function 113, (iii) comparing in real time the Drivers GPS Positions 104 on all route segments present in passengers' 110 pick-up zones, (iv) identifying one En-Route Driver 115 in a pick-up zone nearest to pick-up location of a passenger 110.

Road Impediment Function 106 receives notice that traffic is impaired, from an en-route driver 115 and forward the information to Database 101 to temporarily eliminate the impeded route from consideration.

GPS Cross-Reference Function 113, is wireless connected to any En-Route Driver's Vehicle 115. En-Route Vehicle 115 continuously receives from satellites, the GPS latitude/longitude Vehicle Positions 104 that are forwarded to Cross-Reference Function 113. Cross-Reference Function 113 deciphers and translates the satellites coordinates into coded routes segments for GPS Vehicle Guidance 114.

Having identified an En-Route Driver 115 aiming in a direction passing by the drop-off zone of passenger 110, Routes Matching Process 112 forwards route of identified driver to GPS Vehicle Guidance 114 and forwards trip information of boarding passenger 110 to Seat Tabulating and Balancing Process 116. Vehicle guidance system 114 transmits by wireless the route to be followed to driver 115. Route guidance is provided by a scrolling map, on-board vehicle, eventually coupled with voice guidance.

Seat Tabulating and Balancing Process 116 (i) stores all alternate routes between home drop-off zone and work drop-off zone of passenger 110, (ii) computes the total number of available seats in vehicles having transported passengers to defined work areas (iii) adds the total number of seats occupied by passengers having been transported in the morning, (iv) deduces the number of empty seats in morning vehicles, (v) implements various measures and programs to constantly balance the number of passengers in morning trip with empty seats available for return trip back home (vi) forwards each trip occurrence to the Accounting Data Function 117 for billing passengers and crediting drivers.

### DETAILED DESCRIPTION OF THE INVENTION

Object of the Invention

Occupancy of Vacant Seats

On average, seven out of ten seats in commuting vehicles are not occupied. This available transport capacity can rapidly be adapted and sold at a profit with the business method of the present invention. To accomplish this objective, it is expected that one vehicle out of five presently commuting vehicles is operated by the ridesharing system of the present invention, three drivers abandon solo driving to ride with the system, and one vehicle out of five is still driven by a solo driver.

The present invention is a for-profit business method employing cutting-edge technologies to implement market-driven principles in offering flexible round-trip automobile sharing transits for commuters, on real-time demand.

Improve Traffic and Parking

The object of the present invention is to remove from congested corridors at least one commuting vehicle out of two during commute hours. This would rapidly eliminate road congestion, improve parking in downtown areas, and reduce air pollution; all resulting from overuse of automobiles for commuting.

Commuters initiate forty percent of all automobile trips. Removal from our roadways of half the commute vehicles would reduce non-productive travel time of commuters in congested corridors by some 200 hours per year and per commuter, potentially increasing national labor productivity by 5% to 10%.

National Savings

The present invention can reduce national gasoline consumption by 10% to 20% and air pollution accordingly. Available parking in downtown areas would double. National investment in road works and subsidized public transportation to alleviate present traffic congestion for both commuters and freight carriers would be reduced by tens of billions of dollars per year. Such proposed achievements should receive the support of energy conservation groups, environmental groups, economists, politicians, and business. Or so it seems.

Time Saving

A twenty-miles commute may take a solo driver 45 minutes each way during commute hours and 30 minutes in clear traffic. Another 15 minutes is needed to park and to walk to and from the place of work. This solo driver total commute time is one hour and 45 minutes each way. By becoming a passenger with the ridesharing system of the present invention, that takes him door-to-door in few minutes notice, this solo driver stands to save one hour and 30 minutes a day in commute time. The objective benefit for solo drivers is to reduce by half their yearly commuting cost.

Personal Savings

If one mile of commuting costs a solo driver an estimated 50 cents, (including city parking,) the present invention brings the following benefits: (i) a saving of 25 cents per mile to the ex-solo driver when charged 25 cents a mile as a passenger, (i) it pays driving expenses for commuting and provides a vehicle outside commute hours, to a driver carrying at least three passengers, (iii) to the system operator it provides 25 cents a mile for all its operation, including fully insuring passengers, drivers and vehicles. A typical $10 cost per day for a commuter traveling 40 miles round trip with the present system is equivalent in cost to a typical mass transit transport real cost today, when all government subsidies are counted. In addition the ride with the present invention halves the commuting time.

Organization

The present invention provides the means for instant ridesharing on demand in either direction of a commute trip. An affiliated passenger is expected to be picked-up by a driver within three to ten minutes following a call to the system depending on location of passenger and time of travel. Affiliation with the ridesharing system of the invention is motivated by market driven incentives. Drivers derive substantial personal gain for transporting other commuters to work. Bonuses are allocated to overcome specific difficulties. Passengers may receive a bonus to leave at fixed hours from home or from work, or to notify in advance their departure time. Drivers may be paid bonuses to (i) detour an extra distance to pick-up a passenger, (ii) change their time of departure on demand, (iii) keep the same departure time for a period, (iv) notify system of a traffic impediment, (v) drive with a vacant seat in the morning. Participants, whether they are drivers or passengers, are not committed to a fixed system with mandatory departure time, location impositions, and imponderables, as in carpooling. They use the system when they need it for a faster and better commute and to save time, money, or both.

Balancing the number of available seats between seats used in outgoing trips to work in the morning against seats needed for transporting the same passengers back home in the evening is insured by a number of measures and programs. One program imposes a percentage of vacant seats in the morning trips. This percentage is derived from the probability for a vehicle to find passengers for the return trip and for passengers to find a seat to return home. Measures are in place to (i) mandate passengers to specify in advance the time of trip origination during the last quarter end of the commute window period, (ii) mandate drivers to delay the time of origination of a trip to accommodate more passengers.

The present disclosed invention is based on the premise that while it is not possible to predict externally at what time and from what location a commuter leaves home in the morning to go to work at a defined location and return home in the evening, it is nevertheless possible with accumulated data and statistical analysis to anticipate how many commuters will leave a defined area to travel to another defined area, in a defined period of time. Such calculation can be made with a marginal rate of discrepancies. Optimum travel time for commuting can be compressed to a minimum number of peak hours. Gradual elimination of solo drivers in turn improves traffic conditions in peak hours and allows further compression of the optimum travel time.

The system consists of a fleet of conforming automotive vehicles specially equipped with GPS position signals receiver and transmitter, on-board navigational systems, and interactive wireless communication with a central system. The central system maintains databases to store alternate routes for a commute trip.

Architecture

Routes from trip origin to destination are divided into contiguous segments expressed by codes. One segment of route runs between two intersections and indicates cross streets, access or exit freeway ramps, travel duration, and orientation.

A segment is the portion of a route comprised between two intersections and indicates the time duration to travel this segment as well as its orientation relative to a morning trip to a work area, or an end-of-the-day trip back home. At each extremity of a route sequence, all coded segments comprised in pick-up and drop-off zones are parts of the defined route. Segments in pick-up and drop-off zones refer to any proximate roadway leading to a pick-up point or a drop-off point for an affiliated passenger, and a route starting point or a route final destination for a driver. These zones take into consideration one-way streets, on-ramp and off-ramp junctions, green-lights synchronization, and traffic intensity at time of day.

Orientation indicates travel direction of a segment whether it is for a route from residence to work or a route from work to residence. For example, one segment is stored in the database as LGS02LPS. “LGS” indicates that route segment begins at Las Gallinas, “02” represents a 2 minutes travel time, “LPS” that route segment ends at Las Pavadas. Codes for a same segment to be traveled in the opposite direction would be expressed as LPS02LGS.

A sequence of codes for a complete route for a commuter trip contains all codes of all contiguous segments constituting one route from origin to destination. A commute trip summary is stored in database expressed by codes for first and last segments of the trip. A trip summary covers all alternate routes susceptible to take a commuter on a trip from origin to destination. Due to the change in travel directions, these access routes are not the same. It is also considered that drivers and passengers may know the best routes. An overlaying parameter is that allocation of conforming automobiles goes first to drivers commuting the longest distances.

Alternate routes can be constructed on demand when a passenger needs transport for a nonconforming trip not on record, although such performance will require a different software program. In addition to distinct sequences of codes for alternate routes, an access zone and a drop-off zone delineate proximate routes leading to pick-up or drop-off a passenger. Both, pick-up and drop-off zones, encompass all route segments allowing a driver, within a pre-determined range, to rapidly pick-up or drop-off a passenger. All coded segments situated at specific distances of the passenger pick-up or drop-off location identify the access routes.

Under specific parameters, coded segments are stored in system database for the system to recognize the routes of drivers heading to or near the location of a passenger to be picked-up or dropped-off Both pick-up zone and drop-off zone contain the coded segments of all possible routes leading to a pick-up or a drop-off location, whether it is for a pick-up at the home location or a pick-up at the work location; or a drop-off at the work location in the morning and a drop-off at the home location in the evening.

Affiliated participants may elect to subscribe to different routes for their commute trips. In such instances, each separate route is stored as pertaining to a different person and a personal code and possible different phone number identifies each trip.

A route a driver is directed to follow reflects a probability value of finding passengers along the way. This probability is calculated using fuzzy logic allocating values to the probability the pick-up zone of a passenger is likely to be traversed by the driver, on any alternate routes, at a median time the passenger is likely to ask for transpot. At the time a driver initiates a trip, a probability of finding passengers along any alternate routes stored for this driver is calculated by attributing a value for the probability of finding passengers near any alternate routes, requesting transport for a destination same as driver, at the time the driver will be in the pick-up zone of these passengers.

A value is related to the median time a passenger requests rides over a period of weeks. If one passenger requests rides between 8.00 am and 8.20 am most of the time, the median request time of this passenger is 8. 10 am. For an en route driver passing by the pick-up zone of this passenger at 8.15 am, the probability value of this passenger is high. The closer a passenger is to the position of the en route driver when driver will traverse the pick-up zone of the passenger, and the higher is the value attributed to the passenger pick-up at the time. If alternate route “A” shows five passengers having a median time request for transport five minutes away from the driver real time en route position, while alternate route “B” shows one passenger having a time median request for transport five minutes away, the driver is directed on route “A”.]

Accordingly, based on statistical records, all potential passengers along an alternate route are attributed values at the time an en route driver will be approaching their pick-up zones within three to five minutes. This probability value is provided to the driver who may then decide whether or not to drive. In the event the probability value is not sufficient, the driver may decide to wait and chance to improve the probability, or to be a passenger in another vehicle.

Revenues

Passengers pay system monthly according to trips and miles driven. To insure reliability flexibility and efficiency in the system, transport cost varies according to given factors: (i) Passengers with a regular place and time of departure from home and the work place pay less. (ii) Passengers with imposed time for return trip pay less. (iii) Passengers traveling during prescribed hours pay less.

(iv) Passengers calling a specified time in advance of pick-up time pay less.

Operative Model for Driver

Automobiles are owned either by system operator, a vehicle manufacturer, a county, a state, or an independent company. Individuals drive them under various arrangements.

In order for a driver to drive a vehicle affiliated with the system, and benefit from fare paying riders, driver and vehicle meet specific criteria: (i) Vehicle conforms to a standard for maintenance, comfort, and cleanliness. (ii) Approved vehicle is either owned or leased by driver. (iii) Vehicle is equipped with approved equipments; (iv) Driver has a clean penal record and no traffic violations. (v) Drivers must report code of conduct violations by passengers.

Privately owned automobiles may qualify when conforming to norms. Drivers are pre-qualified. A tag on windshield identifies vehicle. Each driver, upon joining the system, is registered in the system database according to regular place of departure and place of destination. A satellite tracking system tracks the position of every vehicle and monitors their routes.

When a driver calls the system before initiating a trip, the program already knows the route and positions where the vehicle is likely to be at any given time. (i) Driver gives a code and a time of departure. (ii) System informs driver of probability of finding passengers based on historical data of transport request times, and current demand. (iii) Driver decides to drive to work and pick-up passengers along the way or, (iv) When probability of finding passengers is low, driver opts to be a passenger, or drive without compensation from passengers.

Drivers receive monthly a payment for passengers transported according to variable factors intended to increase flexibility and dependability. Participants outside a defined pick-up territory can only be drivers. Revenue received from passengers is sufficient to fully reimburse drivers of vehicles expenses and parking costs, provided driver takes on average three riders per trip. The system revenues are a percentage of the fees paid by passengers.

Operative Model for Passengers

To be affiliated with the system and board a system's operated vehicle, a passenger meets certain conditions: (i) has a legitimate address and clean penal background, (ii) provides locations as to origin and destination of their regular daily commute, (iii) elects to have one or more fixed place and time for trip origin and destination (iv) is attributed a personal code to be used when calling for a ride, (v) receives an identifying badge visible at night for off-the-street pick-up.

Affiliated passengers call minutes before the contemplated time of departure, and provide their personal code. (i) System recognizes the phone number and code of the passenger, hereby retrieving the passenger's location and destination. (ii) Computer searches for all vehicles heading near passenger destination (iii) Computer searches for a vehicle on a route segment within the pick-up zone of passenger's location (iv) Computer identifies a vehicle and instructs driver of an impeding pick-up. (v) Central system inputs vehicle on-board navigational system instructions of fastest route to pick-up passenger and resume route to destination.

Based on a mile cost for vehicle driver of 50 cents (including city parking,) a passenger being charged 25 cents a mile pays $10 a day for a 40 miles round-trip, or about $2,000 a year. The same solo commuter using his own vehicle pays $20 daily when parking is included, or $4,000 annually.

Operation

Using “fuzzy logic” and semi-random search, a software program eliminates by steps any lack of concordance between descriptions of potential routes to be taken by drivers and potential routes for a trip wanted by passengers, matching passengers and drivers at any moment by tracking positions and destinations of all en-route participating vehicles. The program tracks vehicles as they originate their commutes by receiving from vehicles in transit their GPS positions. When a call is received for a ride, the system analyzes all drivers in progress on routes segments, identified in the passenger pickup zone. It then alerts the nearest driver for the pick-up, based on final destination and vacant seats on board.

In a first step, the central system software program retrieves from the database the codes of trips summaries suited to transport an affiliated passenger, from origin to destination. In a second step, the program searches by stored pick-up zones the coded segments leading to passenger's pick-up location. In a third step, the program searches by coded segments all vehicles proximate to passenger's pick-up location with an available seat. In a fourth step program identifies the nearest en-route driver heading for passenger's destination. In a fifth step any signal of a road impediment attached to a route segment prevents the system from choosing this particular route.

A pick-up zone typically gives driver thirty seconds to react to a request for a ride and, with directions from on-board navigational guidance, reach within three minutes a pick-up location. If no appropriate driver is found in the zone, a driver is located further away, giving three to five minutes for driver to reach passenger's location.

When a driver is en route to pick-up a passenger, the computer assigns the stored route of the picked-up passenger as the new route for the driver's on-board navigational guidance. This new route is monitored by the center to pick-up the next passenger.

Drivers are rewarded to report to the system traffic impediments as they discover them and the system provides alternate routes. Incentives are offered to motivate drivers to longer detours to drop-off passengers that guarantee transport when necessary.

Several measures insure enough seat capacity to guarantee that every passenger has a seat in a vehicle to return home. Excess capacity in available seats for the return trips back home is created by: (i) having as many drivers as possible come from as far as possible (ii) having vacant seats in morning trips, (iii) limiting the guaranteed return provision to specific commute hours (iv) having drivers detour extra-distances to pick-up passengers that may otherwise be stranded. It is expected that the majority of commuters work in limited areas of big cities and that detours to find passengers in work area will shorter than detours to bring them home.

Transfer Stations

A ridesharing system using the present invention for a large metropolis may need transfer stations on the main access roads for passengers involved in a long commute to reach their destination in a least amount of time. The route is then divided into two or three sections, each section being treated as a separate route.

Theoretical Study of the System

A theoretical study is an integral part of this invention and consists in the construction of a virtual model after an extensive survey of all residents in a defined geographical area has been conducted. A population survey, not only provides the coordinates of the resident's commutes it also indicates their acceptance and preferences for participating in the system. Without real data, parameters and variables of the virtual model would be of little value.

The virtual model is constructed to run simulated operations of an actual system and to define the optimum parameters and real time variables susceptible to be adjusted to insure maximum efficiency. A theoretical study is undertaken in the area where the system will be operated for the first time. It is expected that variations in parameters and variables will be predicated on numerous factors: (i) geography, (ii) density of commuters per square mile in each area, (iii) number and types of main access roadways. Public acceptance depends a great deal on reliability, which is subservient to extensive theoretical research.

A survey uncovers the intrinsic parameters of the system: (i) areas where passengers can be efficiently picked-up and transported, (ii) density of commuters in sub-divisions of defined residential areas traveling to defined work areas, (iii) percentage of commuters traveling during specific hours, (iv) waiting time before pick-up.

Adjustable variables are calculated from simulated operations and adjusted to maximize performances: (i) optimum number of passengers per vehicle, (ii) length of detour to pick-up a passenger, (iii) excess seat capacity to build in morning transport to insure sufficient seat capacity in the evening. Other field variables are attributes to be measured and manipulated under actual operations: (i) pricing for transport, (ii) payment to drivers, (iii) efficiency bonuses, (iv) waiting time before pick-up.

The foregoing is only intended to explain and illustrate the principle of my invention.

Numerous other arrangements can be developed by those skilled in the art to achieve the same purpose using different approaches:

What I claim is:

1. A system of door-to-door transportation providing on demand ridesharing service to enhance transit during commute hours in congested travel corridors comprising:
a) at least one fleet of specially equipped multi-passengers automotive vehicles,
b) compensated drivers affiliated with said system operating said vehicles,
c) paying passengers affiliated with said system to obtain guaranteed ridesharing on demand to go to a place of work and for returning back home,
d) an information storage and processing center operated with advance communication and data processing technologies.

2. A system of ridesharing as in claim #1 making use of advanced technologies comprising:
1. global positioning system,
2. advanced vehicle wireless communications,
3. automated-real time vehicle tracking and routing,
4. demand responsive vehicle assignment in real time,
5. a said information storage and processing center integrating advanced computer and communication systems technologies to provide said affiliated drivers with said passengers.

3. A ridesharing system as in claim #1 also comprising:
means for storing at least two alternate routes for at least one participant of said system to travel between two stated locations,
means to perform in real time ridesharing matches on demand between drivers and passengers traveling toward a shared destination,
means to locate a pick-up location for at least one of said affiliated passengers requesting a ride,
means to direct at least one said driver on an optimum route to transport at least one of said passengers to a said destination,
means to monitor and guide en-route progress of at least one said affiliated driver to one said destination,
means for a said passenger to notify a third party when arrived at destination,
means for at least one said driver to find out the probability of finding said passengers before originating a commute route.

4. A system of ridesharing as in claim #1 comprising the following steps:
checking credit standing and criminal record for said passengers before affiliation,
checking credit standing, criminal record and driving record for said drivers before affiliation,
billing for transporting said paying passengers on schedule, separately from their rides,
paying said drivers for providing transport on schedule,
insuring passengers, vehicles, and drivers during transport arranged by said system,
monitoring conduct of said passengers and drivers.

5. A ridesharing system as in claim # 1 with on-board means for at least one of said specially equipped automotive vehicle comprising:
a) means to be tracked by said Global Positioning System;
b) means to receive GPS positions of said vehicle while traveling;
c) means to transmit wireless said GPS positions to said center;
d) means to receive wireless travel directions from said center,
e) means to communicate to said driver said travel directions received from said center.

6. A ridesharing system as in claim #1 comprising said specially equipped automotive vehicles leased from a car manufacturer and rented back to said affiliated drivers.

7. A ridesharing system as in claim #1 comprising at least one said vehicle bought from a car manufacturer by said system.

8. A ridesharing system as in claim #1 comprising at least one said vehicle bought from a car manufacturer by a said affiliated driver,

9. A ridesharing system as in claim #1 comprising at least one said vehicle powered by electric batteries.

10. A ridesharing system as in claim #1 comprising at least one said vehicle powered by hydrogen fuel.

11. A ridesharing system as in claim #1 comprising said vehicles being rented for limited hours while not in use to transport commuters.

12. A ridesharing system as in claim #1 comprising said vehicles being used for the carrying of small freight between locations concurrent with the transport of commuters.

13. At least one database compatible with at least one software program, for a demand responsive ridesharing system of affiliated drivers and passengers providing guaranteed door-to-door transportation between two locations for affiliated commuters comprising:
means to define and store at least two alternate routes for a said commuter to travel from a home location to a work location in the morning,
means to define and store at least two alternate routes for a said commuter to travel from a said work location to a said home location in the evening,
means to divide said routes into segments,
means to express at least one of said segments by a code,
means for a said code to express a beginning, an end, and an orientation for at least one said segment,
means to express at least one of said alternate routes by a continuous sequence of codes,
means of defining and storing said sequence of codes for a said alternate route to transport at least one said commuter to a said location,
means to store parameters and variables defining operations procedures,
means to register a road impediment to a said code representing a said segment,
means for storing at least one said coded route segment identifying when a said affiliated driver enters a zone proximate to a pick-up location of a said affiliated passenger when said driver is en route toward said pick-up location of said passenger,
means for storing at least one said coded route segment identifying when a said affiliated driver enters a zone proximate to a drop-off location of a said affiliated passenger when said driver is en route toward said dropoff location of said passenger.

14. At least one database compatible with a least one software program as in claim 13 performing the following functions:
1. Every time a said passenger requests transport, determine a median time for said passenger next day departing time, by storing and averaging all daily departing times of said passenger;
2. Prior to a driver beginning a trip, analyze all said coded segments on all said stored routes for said driver, where said driver is going to be positioned at approximate times during travel;
3. Prior to a said driver initiating a trip, identify on said driver's alternate routes any passenger with a median departing time corresponding with said approximate time when said driver will be in said passenger's pick up zone.

15. At least one database with compatible software program as in claim 13 comprising:
means to retrieve from said database all said sequences of codes of said alternate routes between two said locations,
means to recognize and compare a plurality of said sequences of codes,
means to identify a least one sequence of codes subordinated to parameters and real-time variables stored in said database,
means to retrieve at least one sequence of codes to transport at least one said commuter to one said location,
means for retrieving at least one said coded route segment identifying when a said affiliated driver is en route toward said pick-up location of said passenger and when said driver enters a zone proximate to a pick-up location of a said affiliated passenger,
means for retrieving at least one said coded route segment identifying when a said affiliated driver is en route toward said pick-up location of said passenger, and when said driver enters a zone proximate to a drop-off location of a said affiliated passenger.

16. At least one database with compatible software program as in claim 13 comprising:
means to identify a phone number from a phone call placed by at least one said affiliated commuter,
means to further identify said caller from a given code,
means to differentiate drivers from passengers when said call is received by said system,
means to identify said alternate routes for said caller from said phone number,
means for retrieving from said database any said sequences of codes for commute routes stored in database for said calling affiliated commuters.

17. At least one database with compatible software program as in claim 13 comprising:
means to retrieve from said database any said sequences of codes for a said destination pertaining to said alternate routes to be followed by said en-route drivers;
means to compare and chose a said sequence of codes for a said route to be followed by a nearest driver en-route toward said destination of said passenger;
means to identify at least one said nearest driver in a pre-determined range of a said pickup location;
means to direct at least one said nearest driver on a shortest path for a said pick-up,
means to subsequently direct said driver for a new shortest route to transport a picked-up passenger to a requested destination.

18. At least one database with compatible software program as in claim 13 comprising said affiliated passengers guaranteed ridesharing on demand for transportation from home to a place of work in the morning and also guaranteed transportation from said place of work to return to said home in the evening, also performing the steps of tabulating:
a) a total number of seats in affiliated vehicles originating from at least one defined residential area and having traveled to at least one defined work area in the morning;
b) a total number of occupied said seats in affiliated vehicles originating from said defined residential area and having commuted to said defined work area in the morning;
c) a total number of vacant said seats in vehicles originating from said defined residential and having commuted to said defined work area in the morning;
d) a minimal number of said vehicle seats needed to insure transport of said passengers from said defined work area to said defined residential area in the evening.

19. A database with compatible software program as in claim 13 comprising:
means for at least one said affiliated driver to notify said system before starting a nonconforming trip on a destination for said trip,
means for said system to recognize a said location of a said trip origin and a said location of said trip destination previously stored in said databank but not appurtenant to caller,
means for said system to retrieve a said sequence of codes for a said route going from a said origin to a said destination of said trip;
means for tracking vehicle of said driver with a Geographical Positioning System,
means for wireless equipment aboard vehicle of said driver to transmit on-going positions of said vehicle, to an information processing center,
means for said center to compare and chose all possible said alternate routes to be followed by said driver en route to said destination.

20. At least one database with compatible software program as in claim 13 comprising the following steps:
1) upon coming against a said road impediment interfering with flow of traffic, at least one said driver en-route to a said destination immediately reports said impediment to said system;
2) said system automatically selects a said alternate route and communicates said alternate route to said driver,
3) said system incorporates said traffic impediment to a said route segment related to said location of said traffic impediment,
4) said system assigns a time duration for said impediment based on type of impediment and historical data.

21. A ridesharing system with specially equipped automotive vehicles comprising:
a) regular compensation for drivers based on transported passengers,
b) fares paid by passengers for their transport based on distance and frequency,
c) bonuses paid on special situations to said drivers and said passengers.

22. A ridesharing system as in claim #21 comprising:
a) at least one said driver of a said specially equipped automotive vehicle having employ of said vehicle when not transporting said passengers,
b) at least one said driver of one said specially equipped automotive vehicle having automotive vehicle expenses paid in pro-ration by said system when transporting at least one said passenger.

23. A real time ridesharing system as in claim 21 comprising at least one passenger paying a lower fare as a said bonus for commuting with system in said special situations comprising:
a) commuting within hours prescribed by said system,
b) leaving at a fixed time in the morning,
c) returning at fixed hours in the evening,
d) notifying said system of a departure time, in a required time prior to departure time,
e) waiting longer than normal time for a pickup.

24. A system of ridesharing as in claim 21 with said drivers receiving from said system a bonus on said special situations comprising:
a) transporting at least one said passenger outside defined parameters,
b) detouring an extra distance to pickup at least one of said passenger;
c) changing time of origination of a trip upon request by said system;
d) notifying system of at least one road impediment obstructing traffic;
e) conforming to an imposed time of trip origin;
f) driving a five passenger seats vehicle with at least one vacant seat in morning trips.

25. An extensive population survey for a flexible door-to-door ridesharing system on demand in a defined geographical area followed by a theoretical study to collect and analyze hard data on commuters comprising at least one of the following objects:
a) locations of departure in the morning of said commuters,
b) locations of workplace areas of said commuters,
c) time of origination of commuting trips in both directions,
d) mode of transportation currently used by said commuters,
e) proportion of said commuters presently driving solo,
f) intended participation of said commuter in said ridesharing system,
g) establishing significant incentives for said population to respond to said survey.

26. A population survey as in claim 25 comprising the following steps:
1. collecting, compiling, and analyzing said data collected from said survey,
2. constructing a comprehensive virtual model of said system with related software programs based on said collected data;
3. running simulated ridesharing operations from said model,
4. delimitating fixed parameters and range of variables for said software programs based on said data,
5. defining at least one sub-division within a said defined geographical area,
6. computing the number of commuters leaving from a said area in the morning and going to a specific said workplace area during defined time periods;
7. computing estimated average duration time of travel between passengers pick-up,
8. computing estimated mileage detour to pick-up said affiliate passengers,
9. computing estimated average waiting time for a pick-up after a demand for transport by at least one said affiliated passenger,
10. Identifying all time elements susceptible to be adjusted to transport said affiliated passengers to said destination in a minimum time and with a least advance notice.

27. A population survey for a door-to-door, demand responsive, ridesharing system as in claim 25 polling commuters to find out said commuters intended participation comprising:
a) driving an electric vehicle to transport affiliated passengers,
b) driving an hydrogen fueled vehicle to transport affiliated passengers,
c) paying a refundable deposit on a fully equipped vehicle to be a driver for said system,
d) being a regular passenger on a vehicle operated by said system,
e) being an occasional passenger on a vehicle operated by said system,
f) driving their own conforming vehicle to transport said affiliated commuters,
g) installing said special equipments on their own vehicle to be operational with said system.
